(19) United States
(12) Patent Application Publication
(10) Pub. No.: US 2007/0157758 A1
(43) Pub. Date: Jul. 12, 2007

(54) Handlebar grip

(75) Inventor: Hsi Kai Shih, Puyan Township (TW)

Correspondence Address: BRUCE H. TROXELL;SUITE 1404, 5205 LEESBURG PIKE, FALLS CHURCH, VA, 22041, US

(73) Assignee: Propalm Industry Co., Ltd.

(21) Appl. No.: 11/327,507

(22) Filed: Jan. 9, 2006

(51) Int. Cl. B62K 21/26

(52) U.S. Cl. 74/551.9

(57) ABSTRACT

A handle bar includes an inner rigid shell, an outer cover, a rigid clamp, and a tightening screw. The. inner rigid shell has one end at least provided with plural axial protrusions divided by slits in a circle. One of the protrusions is provided with a position-limiting member on an outer surface, and the rigid clamp is provided with a position-limiting member on an inner surface to elastically engaging with that of the protrusion so that the rigid clamp may be positioned limitedly. relative to the inner rigid shell. At the same time, the rigid clamp is tightened to shrink inward by a tightening screw and subsequently also tightens the plural protrusions of the inner rigid shell around an end portion of a handlebar of a bicycle.

### BACKGROUND OF THE INVENTION

1. Field of the Invention

This invention relates to a handlebar grip, particularly to one conveniently combined with the handlebar with stable tightness.

2. Description of the Prior Art

Bicycles generally have handlebar grips for riders to hold for easily controlling the handlebar, having a rigid inner shell made of plastic, and an outer cover fitting around the rigid inner shell made of rubber. The rigid inner shell is clamped by a rigid clamp, which is provided with a center hole formed at an end, and a tightening screw engages two sides of the end opening to clamp the rigid clamp inward to tightly combine the grip around the handlebar.

However, the rigid clamp is not so easily disfigure flexibly, because of the rigid inner shell that the rigid clamp is combined with. So a U.S. patent of the serial No. U.S. Pat. No. 6,263,756 disclosed a handlebar grip, which is provided with plural axial protrusions on an end of a rigid inner shell, and a rigid clamp is provided with plural protrusion receiving recesses for fitting with the axial protrusions stably, so when the rigid clamp is forced to tighten inward by a screw, the inner surface of the rigid clamp directly constricts the outer surface of the handlebar, and at the same time the recesses can also protrudes lengthwise to tighten the outer surface of the handlebar so that the grip may be tightly fixed around the handlebar.

The referred US patent still has the following disadvantages.

1. Though the rigid clamp can make the recesses to protrude lengthwise to indirectly tighten on the handlebar, a large portion of the tightening force comes from the inner surface except the recesses directly contacting the handlebar. Further, the rigid clamp is made of hard metal, apt to damage the outer surface of the handlebar, especially if the handlebar is made of carbon fiber, resulting in lowering the strength of the handlebar, and breaking it if worse.

2. The rigid clamp has the recesses to fit with the lengthwise protrusions of the rigid inner shell, but when the clamp is tightened by the screw, the rigid clamp may also disfigure flexibly by lengthwise protrusions, decreasing clamping effect.

3. The recesses of the rigid clamp are not axial, but lengthwise on an end surface, so the end of the rigid clamp where the recesses exist is to face the rigid inner shell in case of combining the rigid clamp with the rigid inner shell. So their combination may be affected by the directional limitation, slowing their combining work.

### SUMMARY OF THE INVENTION

This invention has been devised to offer a handlebar grip improved in the disadvantages of the conventional handlebar grip.

The feature of the invention is an inner rigid shell provided with plural protrusions at one end of a grip, and the protrusions are divided by plural slits in the condition spaced apart equidistantly to form a circle. Then a metal rigid clamp fits around the outer surface of the protrusions, and at least one of the protrusions is provided with a position limiting member on an outer surface, and the rigid clamp is provided with a position limiting member to elastically engaging with that of the protrusion so that the rigid clamp may be positioned limitedly relative to the inner rigid shell. At the same time, the rigid clamp is tightened by a tightening screw to shrink inward to force the protrusions of the inner rigid shell to tightly press against the outer surface of an end portion of a handlebar of a bicycle. Thus the handlebar grip is tightly fitted around the handle bar, without harming the handlebar, and moreover, the combination of the rigid clamp and the protrusions of the inner rigid shell is not limited in the axial direction and is kept in an elastic engagement, even if the tightening screw is not yet used. Therefore, subsequent package and transportation can be carried out very conveniently.

### BRIEF DESCRIPTION OF DRAWINGS

This invention will be better understood by referring to the accompanying drawings, wherein:

FIG. 1 is a perspective view of a first embodiment of a handlebar grip in the present invention;

Figure is a partial exploded perspective view of the first embodiment of a handlebar grip in the present, invention;

FIG. 3 is a perspective view of the first embodiment of a handlebar grip fixed around a handlebar in the present invention;

FIG. 4 is a cross-sectional view of the first embodiment of handlebar grip fixed on a handlebar in the present invention;

FIG. 5 is an exploded perspective view of a position-limiting member of a rigid clamp and one of protrusions of the inner rigid shell in the present invention;

FIG. 6 is an exploded perspective view of another position limiting member of a rigid clamp and one of the protrusions of the inner rigid shell in the present invention;

FIG. 7 is a perspective view of another embodiment of the rigid clamp in the present invention;

FIG. 8 is a partial perspective view of a second embodiment of a handlebar grip in the present invention;

FIG. 9 is a partial exploded perspective view of the second embodiment of a handlebar grip in the present invention; and,

FIG. 10 is a cross-sectional view of the second embodiment of a handlebar grip in the present invention.

### DFTAILED DESCRIPTION OF THE PREFERRED EMBODIMENTS

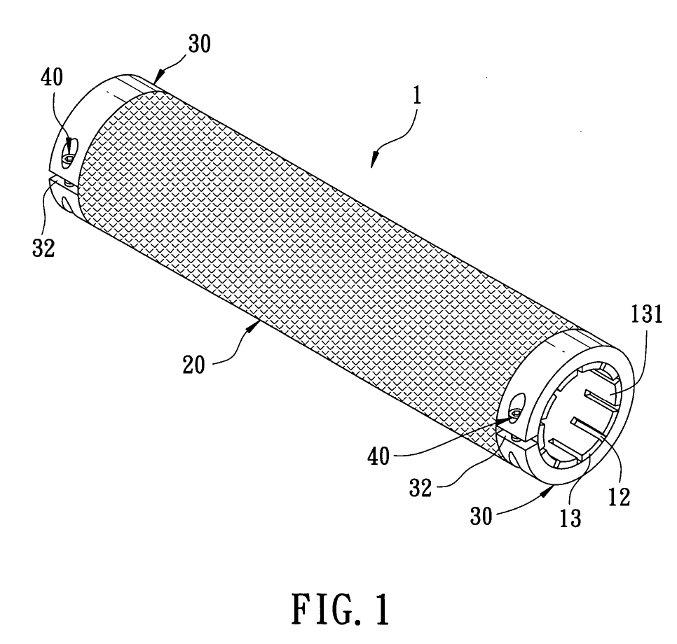

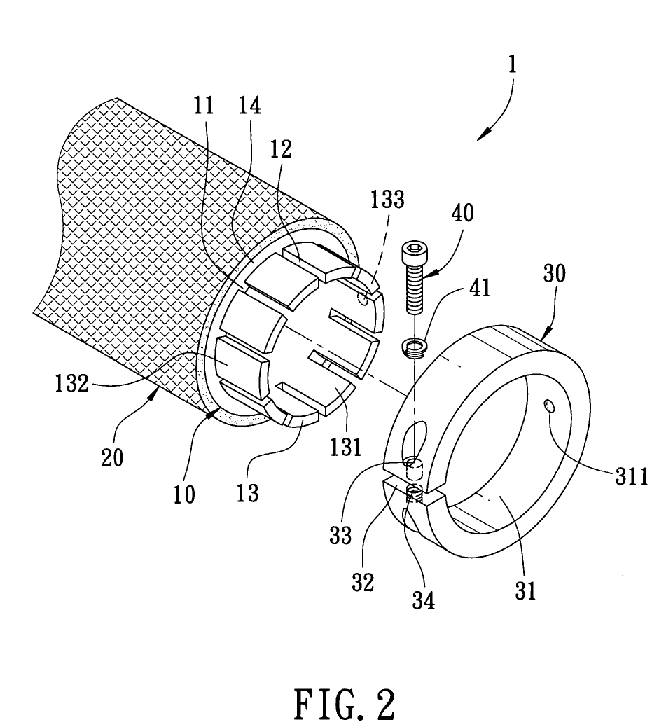

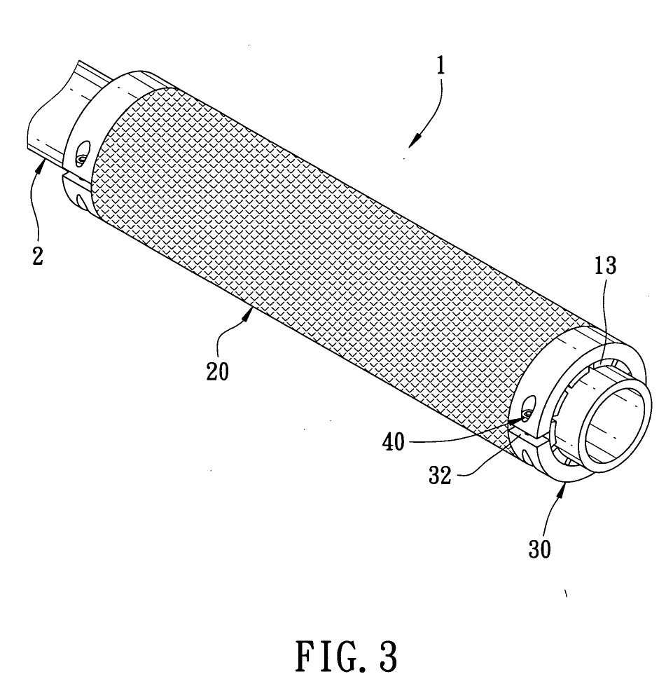

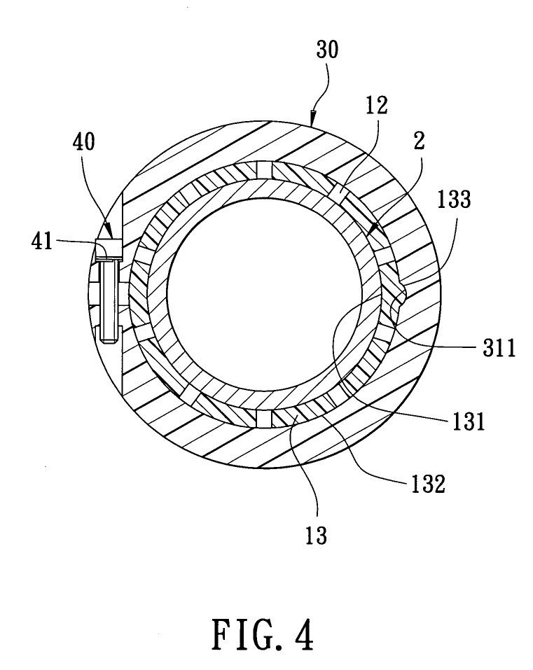

A first preferred embodiment of a handlebar grip in the present invention, as shown in FIGS. 1 to 4, includes an rigid inner shell 10, an outer cover 20 fitting around the rigid inner shell 10, two rigid clamps 30 and two screws 40.

The rigid inner shell 10 is made of plastic, having two ends 11, plural curved protrusions 13 protruding axially from a first end 11 and divided equally with plural slits 12. Each curved protrusion 13 has an inner surface 131 extending from the wall of the rigid inner shell 10. The first end 11 of the rigid inner shell 10 has an annular stop surface 14 where the lower end of the curved protrusions 13 is. Further, at least one of the curved protrusions 13 has a grain projection 133 on an outer surface.

The outer cover 20 is made of rubber, having some elasticity to tightly fitting around the outer surface of the handlebar 2 of a bicycle or the like.

The two rigid clamps 30 are made of metal such as aluminum, shaped as C with a gap 32, having an annular inner surface 31. Each rigid clamp 30 has a hole 33 and a threaded hole 34 respectively provided at two sides of the gap 32, and a recess 311 formed in the inner surface 31 corresponding to the grain protrusion 33 of the rigid clamp 30, making up a position limiting structure with the grain protrusion 33 so that the rigid clamp 30 may be positioned elastically limited axially and annually with the rigid inner shell 10 by engagement of the recess 311 and the grain protrusion 133.

The two tightening screws 40 are attached with a metal spring lock washer 41, which is inserted in the hole 33 through the gap 32. Then each screws 40 engages with the threaded holes 34, forcing the rigid clamp 30 shrink inward so as to tighten the curved protrusions 13 of the rigid inner shell 10, so the grip may fit hard and stably around the handlebar 2.

In assembling, after the rigid inner shell 10, the outer cover 20 and the rigid clamps 30 are separately made, its assembly will be preformed before subsequent package and transportation. Firstly, the rigid clamp 30 is fitted around the first end of the rigid inner shell 10, with the inner surface 31 contacting the outer surface of the curved protrusions 13 of the rigid inner shell 10 and with the recess 311 engaging with the grain protrusion 133, Then the recess 311 of the rigid clamp 30 engaging with the grain protrusion 13 functions to limit the position of the rigid clamp 30 axially and circumferentially, with the rigid clamp 30 prevented from easily loosening off the rigid inner shell 10, helpful for subsequent package and transportation. Therefore, the tightening screw 40 is not necessary to be assembled together, possible to be packed as an accessory for later assembly, though it can be assembled before packaging, without completely screwed tight.

Next, when a user or maker wants to install the grip 1 on the handlebar of a bicycle 2, the grip 1 assembled with the inner rigid shell 10, the outer cover 20 and the rigid clamp 30 can be inserted to fit around an end portion of the handlebar 2, and then the tightening screws 40 of the two rigid clamps 301 are driven forcefully, shrinking the rigid clamps 30 inward and subsequently also the curved protrusions 13 of the rigid inner shells 10 inward, so the curved protrusions 13 disfigure to strongly constrict the handlebar 2.

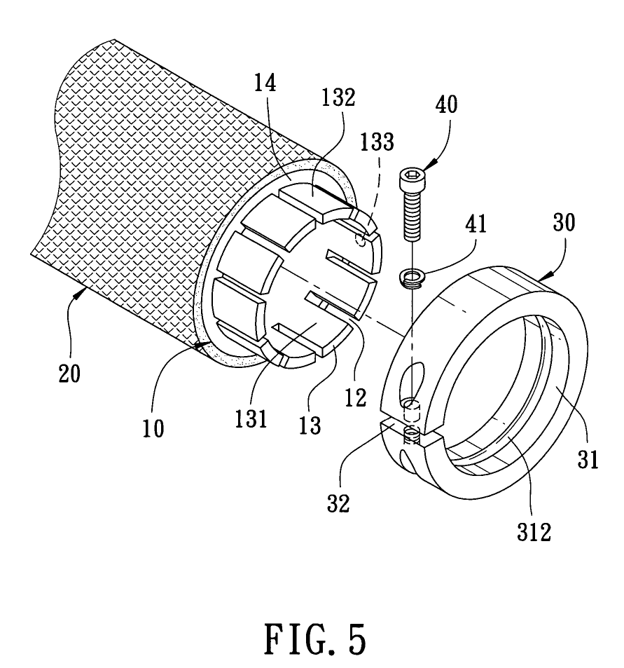

Next, FIG. 5 shows a second position limiting structure, wherein the inner shell 10 has at least one of the curved protrusions 13 provided with a grain protrusion 133 on an outer surface 132, and the rigid clamp 30 has an annular position groove 312 in an annular inner surface 31. So when the inner surface 31 of the rigid clamp 30 contacts the outer surfaces 132 of the curved protrusions 13, the annular position groove 312 may fit with the grain protrusion 133 so as to restrict the rigid clamp 30 elastically and axially.

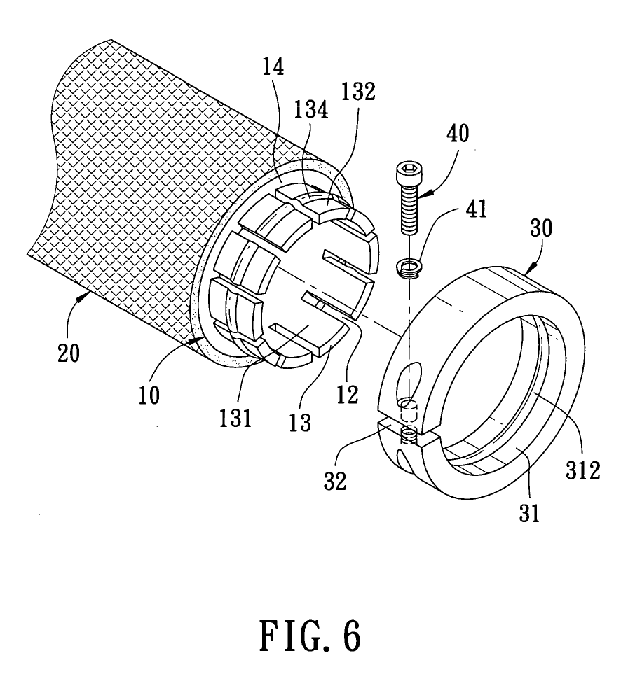

Further, FIG. 6 shows a third position limiting structure, wherein all of the curved protrusions 13 are formed with a circumferential ridge 314 in an intermediate portion of the outer surface, and the rigid clamp 30 is provided with an annular groove 312 in the same way in the second one. Then the engagement of the circumferential ridges 314 with the annular position groove 312 can restrict the position of the rigid clamp 30 relative to the inner shell 10 axially and circumferentially.

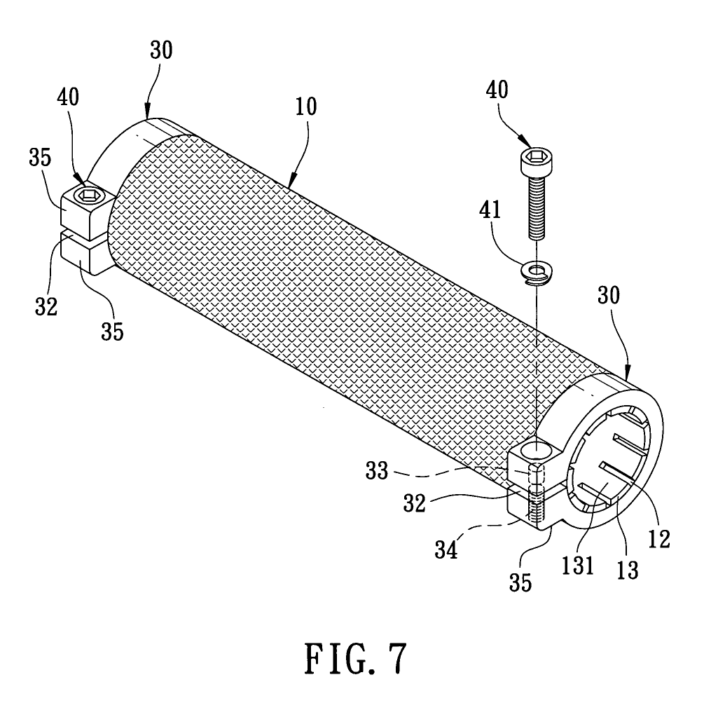

Next, FIG. 7 shows a second embodiment of a rigid clamp 30, wherein the rigid clamp is provided with a thick head 35 at two sides of a gap 34, and the head 35 is provided with a hole 33 and a threaded hole 35 for a screw 40 to engage therein to tighten the rigid clamp 30.

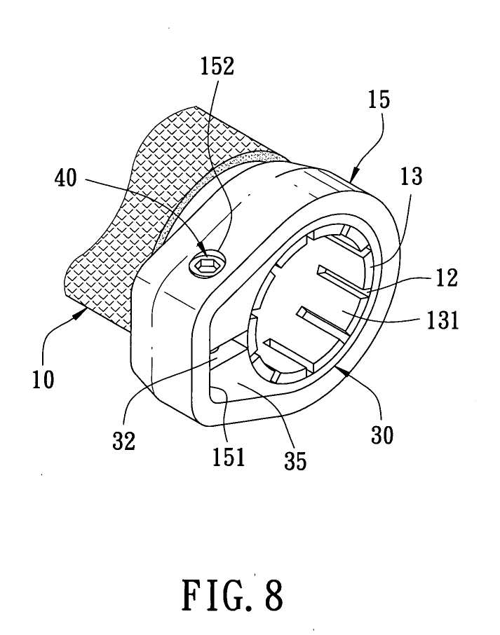

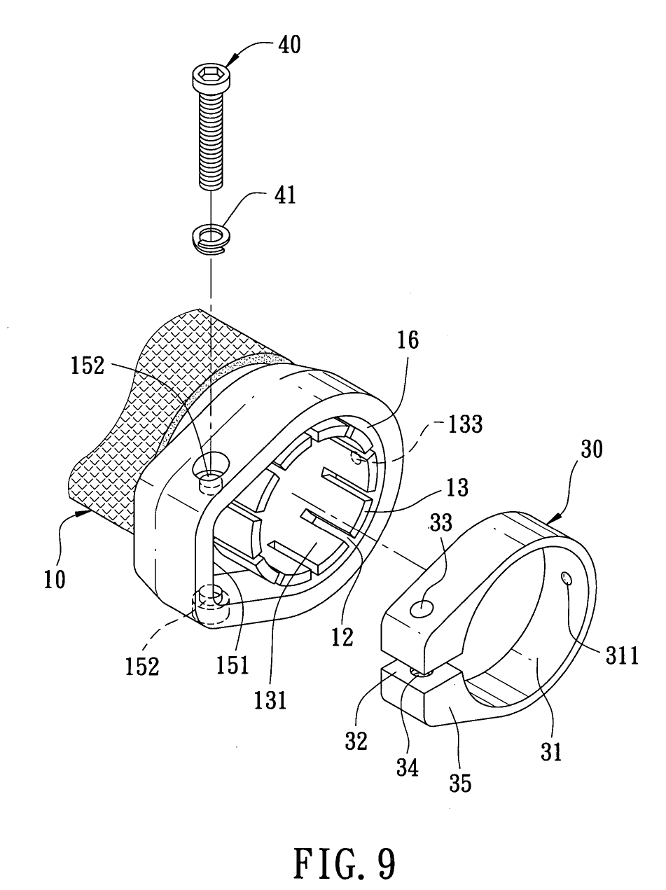

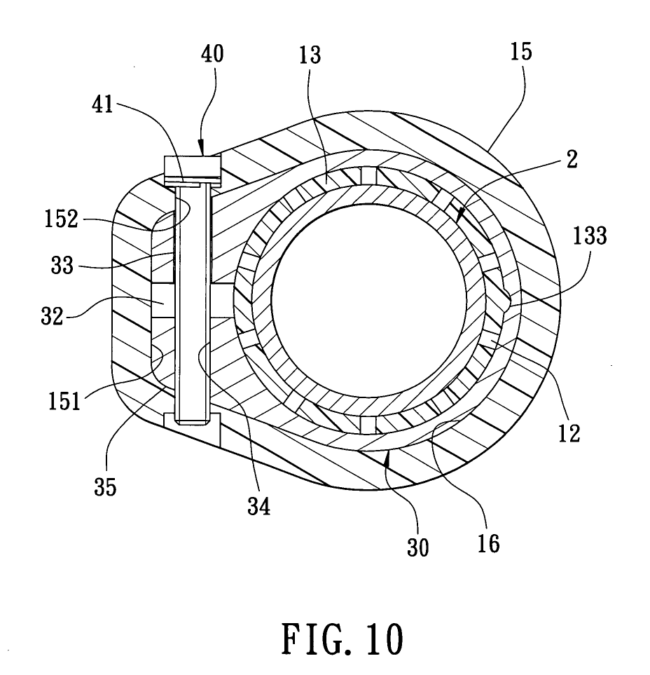

Next, a second embodiment of a handlebar grip shown in FIGS. 8, 9 and 10 has almost the same structure except that an accommodating base 15 is added to at least one of two ends of the rigid inner shell 10, extending to surround and be separated from the curved protrusions 13 by an annular groove 16, having a position recess 151 on an annular inner surface 15 and two holes 152 at two sides of the position recess 151. So the rigid clamp 30 with the two heads 35 of the first embodiment may fit in the annular groove 16 and the position recess 151 respectively, with the tightening screw 40 engaging the threaded holes 34 after passing through the two holes 151. Thus the rigid clamp 30 is forced to shrink inward, further coercing the curved protrusions 13 so as to constrict closely the handlebar 2, as does the first embodiment.

The invention has the following advantages as can be seen from the foresaid description.

1. The curved protrusions 13 extending from the end of the rigid inner shell 10 have high flexibility in the diametrical direction, so they can easily shrink inward diametrically in case of receiving pressure from the metal rigid clamp 30, and subsequently tightly and steadfastly fasten against the handlebar 2, preventing the grip 1 from loosening off the handlebar 2.

2. The rigid clamp 30 is provided with the annular inner surface 31, so the hard material of the rigid clamp does not contact directly the handlebar 2, but separated by the curved protrusions 13 made of comparatively soft material, plastic of the inner rigid shell 10, so the outer surface of the handlebar 2 may be not be harmed by the metal rigid clamp 30. And especially if the handlebar 2 is made of carbon fiber, it may be better protected in this way, without nay fear of damage or break.

3. The combination of the rigid clamp 30 and the curved protrusions 13 of the inner shell is not limited in the direction, in other words, no directional limitation for its axial combination, especially the provision of the grain protrusion 133 on the outer surface of one of the curved protrusions 13 engaging the annular groove 312 of the rigid clamp 30 can remove any directional limitation. Similarly, the circumferential ridges 134 on the outer surface of the curved protrusions 13 fitting in the annular groove 312 of the rigid clamp 30 can function as the same way described just above. In addition, the position limiting structure formed by the rigid clamp 30 and the curved protrusions 13 can give rise to a position limitation in an axial direction, even if the tightening screw 40 is not yet used after the rigid clamp 30 has been fitted around the curved protrusions 13. So the rigid clamp 30 may not easily loosen, or fall off the inner rigid shell 10 in the subsequent package and transportation of the grip 1.

4. The rigid clamp 30 provided with the inner surface 31 can be made by forming a long metal tube in an extracting method first, and then the metal tube is cut into many separate rigid clamps, easily made and lowered in its cost accordingly.

While the preferred embodiments have been described above, it will be recognized and understood that various modifications may be made therein and the appended claimed are intended to cover all such modifications that may fall within the spirit and scope of the invention.

What is claimed is:

1. A handlebar grip comprising an inner rigid shell made of plastic and an outer cover fitting around said inner rigid shell so as to tightly forcing said inner rigid shell fitting around a handlebar of a bicycle;
said inner rigid shell provided with a plural curved protrusions extending axially from an end circumference and formed in a circle and divided by plural slits spaced apart equidistantly, said curved protrusions having an inner surface extending from an inner surface of said inner rigid shell, said inner rigid shell having its end formed with an annular stop surface at a lower end of each said curved protrusion;
at least one rigid clamp made of metal and shaped as C. said rigid clamp having an annular inner surface and a gap communicating with said annular inner surface, a hole and a threaded hole provided at two sides of said gap, said inner annular surface of said rigid clamp contacting an outer surface of each said curved protrusion;
at least one tightening screw passing through said holes and engaging with said threaded hole of said rigid clamp, said screw screwed inward to force said rigid clamp shrink inward diametrically so that said curved protrusions of said inner rigid shell may be accordingly tightened to disfigure inward diametrically to tightly fasten against said handlebar.

2. The handlebar grip as claimed in claim 1, wherein at least one of said curved protrusions is provided with a position limiting structure and said rigid clamp is provided with a position limiting structure, so that both said position limiting structures can elastically engage with each other.

3. The handlebar grip as claimed in claim 2, wherein said position limiting structure of said curved protrusion and said rigid clamp are formed by at least a grain protrusion provided on an outer surface of said curved protrusion and at least a recess formed in said annular inner surface of said rigid clamp.

4. The handlebar grip as claimed in claim 2, wherein said position limiting structure of said inner rigid shell and said rigid clamp are formed by a grain protrusion provided on an outer surface of one of said curved protrusion and an annular groove provided in said inner surface of said rigid clamp.

5. The handlebar grip as claimed in claim 2, wherein said position limiting structure of said inner rigid shell and said rigid clamp are formed by an annular ridge provided on all said curved protrusions and an annular groove provided in said inner surface of said rigid clamp.

6. The handlebar grip as claimed in claim 1, wherein said rigid clamp is provided with a thick head at two sides of said gap, and said thick heads are provided respectively with a hole and a threaded hole aligned to each other.

7. The handlebar grip. as claimed in claim 6, wherein said inner rigid shell has at least one end provided with an accommodating base, between an inner surface of said accommodating base and the outer surface of said curved protrusions is formed an annular groove, a position recess is formed on the inner surface of said accommodating base, a hole is bored in two sides of said position recess, so said rigid clamp with said two thick heads may be received in said annular groove and said position recess, with said tightening screw passing through said hole and engaging said threaded holes for tightening said rigid clamp.

8. The handlebar grip as claimed in claim 1, wherein said tightening screw is fitted around with a spring lock washer.
